(19) United States
(12) Patent Application Publication
(10) Pub. No.: US 2025/0028936 A1
(43) Pub. Date: Jan. 23, 2025

(54) APPARATUS AND METHOD FOR ESTIMATING THE ILLUMINATION OF AN AMBIENT

(71) Applicant: FONDAZIONE ISTITUTO ITALIANO DI TECNOLOGIA, GENOVA (IT)

(72) Inventors: Theodoros TSESMELIS, GENOVA (IT); Nicolò CARISSIMI, GENOVA (IT); Alessio DEL BUE, ALBISSOLA SUPERIORE (IT)

(21) Appl. No.: 18/710,700

(22) PCT Filed: Nov. 4, 2022
(86) PCT No.: PCT/IB2022/060634

§ 371 Date: May 16, 2024

(30) Foreign Application Priority Data
Nov. 16, 2021 (IT) 102021000029003

(51) Int. Cl. G06N 3/0464; G06N 3/084

(52) U.S. Cl. CPC G06N 3/0464; G06N 3/084

(57) ABSTRACT

A method for estimating at least one illumination value of an ambient includes a) an acquisition phase, wherein ambient data which define a plurality of points detected in the ambient, emission data defining a first set of the points that represent light sources, and illuminance data defining a second set of the points that represent the illuminated ambient are read, b) a training phase, wherein a neural network is trained by inputting the ambient data and the emission data, forcing the output of the illuminance data, c) a determination phase, wherein second illuminance data are determined, by means of the neural network, on the basis of the ambient data and second emission data.

The present invention relates to a method and an apparatus for estimating at least one illumination value of an ambient where light sources are present, in particular an indoor or partially closed ambient, e.g. a room, an office, a laboratory, a covered terrace, or the like.

As is known, aiming at reducing the consumption of electric energy for the illumination of indoor or closed environments, simulation software is commonly employed (e.g. DIALux™, AGI32™, Relux™, using algorithms such as Radiosity) which permits predicting the quantity of light within ambients based on the type of illumination system installed therein and/or the characteristics of the surfaces and/or the presence or absence of natural light sources (e.g. windows, openings to the outside, or the like).

These software programs require, however, a geometric/vectorial model of the ambients, for the creation of which the intervention of a CAD (computer-aided design) operator is needed to convert a survey, e.g. obtained by photogrammetry, laser scanning, radar scanning, or the like, into a vectorial format that, as is known, produces a cloud of points, with each of which a property, e.g. colour, brightness, temperature, or the like, can be associated.

The need for using geometric/vectorial models makes it impossible to use such simulation techniques within a high-automation context, in which a large number of simulations are carried out for a large number of ambients, or within contexts where ambient illumination systems are controlled in real time based on the presence of natural light and/or other factors.

The scientific article by Yue Liu et al. entitled “Computing Long-term Daylighting Simulations from High Dynamic Range Imagery Using Deep Neural Networks”, 2018, describes a method for estimating the luminance of natural light sources (e.g. windows) that are present in environments represented as a cloud of points. This method does not, however, permit estimating the illumination of points not representing a light source.

The present invention aims at solving these and other problems by providing a method and a processing device for estimating at least one illumination value of a three-dimensional ambient where one or more light sources of different nature are present.

Moreover, the present invention aims at solving these and other problems by providing also an apparatus for estimating at least one illumination value of an ambient where one or more light sources are present.

The basic idea of the present invention is to use a neural network for predicting the illuminance values of a cloud of three-dimensional points (referred to as ambient data) that represent an ambient where (artificial or natural) light sources are present and in a given state, wherein said neural network is trained by inputting to it the ambient data and emission data defining, for each point belonging to a light source, at least one light emission value, and by forcing said neural network to output illuminance data that define, for each illuminated point (i.e. each point not belonging to a light source) at least one illuminance value representing an illumination intensity received in an emission condition of the light sources, wherein said emission condition is defined by a set of emission values comprised in said emission data.

These features allow estimating the illumination of three-dimensional ambients defined by means of a cloud of points (e.g. a sparse model). In this way, simulation times are reduced for both simple and complex environments, and these models can be used for controlling the ambient illumination in real time, without having to use a geometric/vectorial model to make the illumination estimates and/or without requiring the intervention of a CAD operator to convert a sparse model of an ambient (whether physical or virtual) into a geometric/vectorial model.

Further advantageous features of the present invention will be set out in the appended claims.

These features as well as further advantages of the present invention will become more apparent in the light of the following description of a preferred embodiment thereof as shown in the annexed drawings, which are provided merely by way of non-limiting example, wherein:

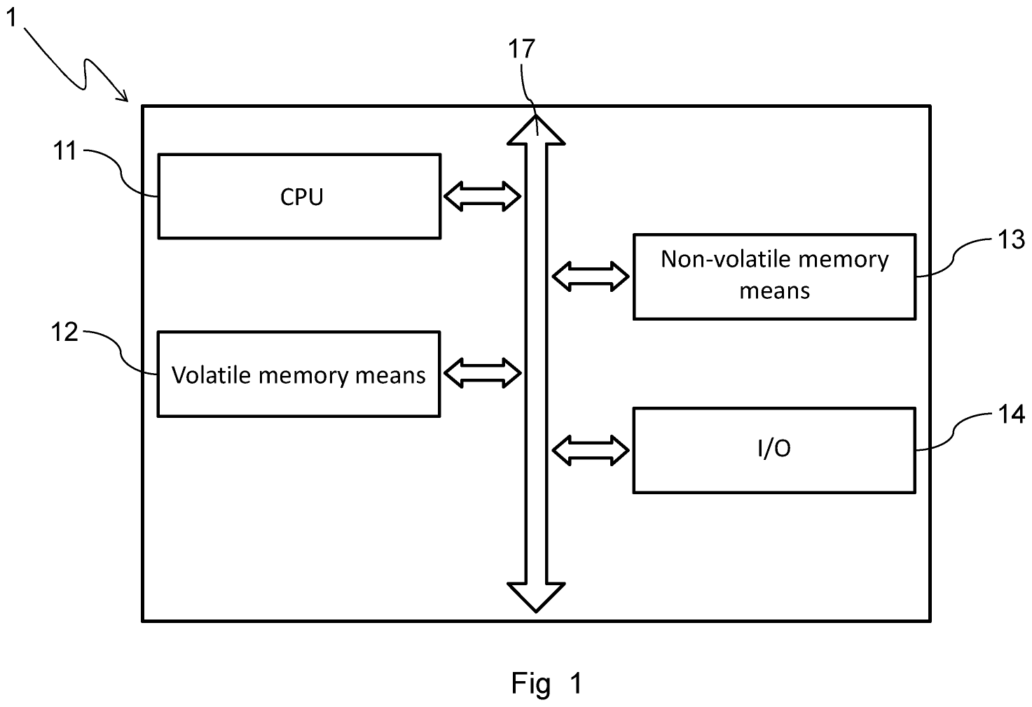

FIG. 1 shows a block diagram of a device implementing a method for estimating the illumination of an ambient according to the invention;

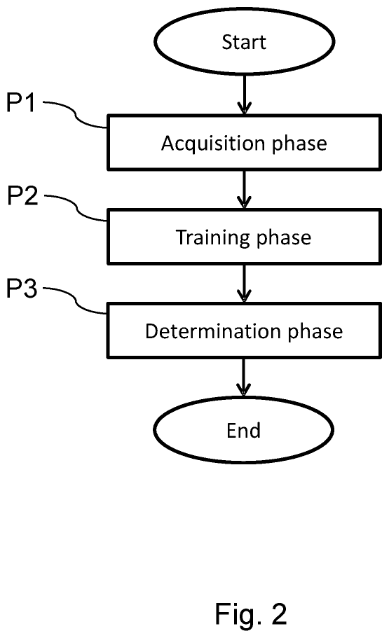

FIG. 2 shows a flow chart of the method for estimating the illumination of an ambient according to the invention;

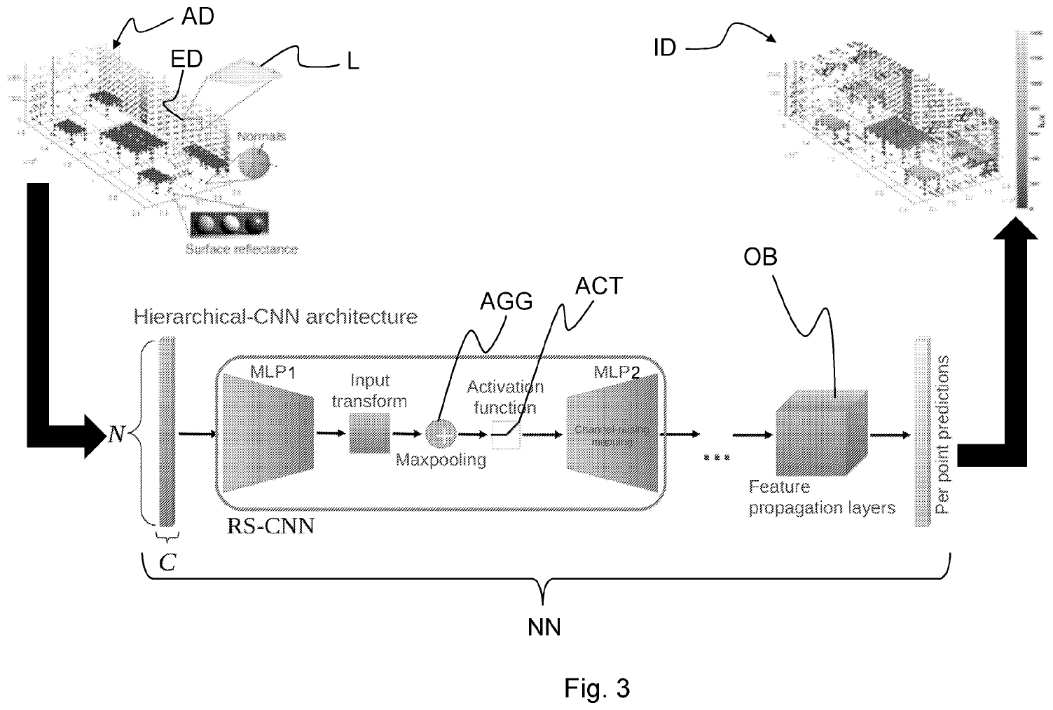

FIG. 3 shows a flow chart comprising a neural network used by the method of FIG. 2;

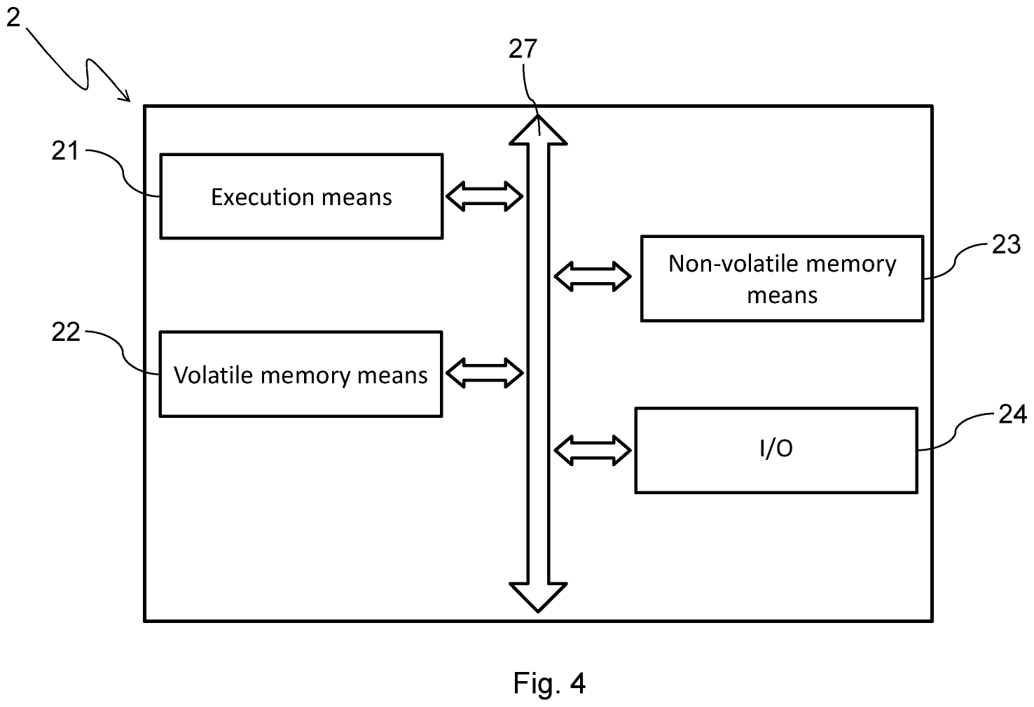

FIG. 4 shows a block diagram of an apparatus for estimating the illumination of an ambient by means of the neural network of FIG. 3.

In this description, any reference to “an embodiment” will indicate that a particular configuration, structure or feature is comprised in at least one embodiment of the invention. Therefore, expressions such as “in an embodiment” and the like, which may be found in different parts of this description, will not necessarily refer to the same embodiment. Moreover, any particular configuration, structure or feature may be combined as deemed appropriate in one or more embodiments. The references below are therefore used only for simplicity's sake, and shall not limit the protection scope or extension of the various embodiments.

With reference to FIG. 1, an embodiment of a processing device 1 (e.g. a server, a cluster of servers, a PC, or the like) implementing a method according to the invention comprises the following components:
control and processing means 11, e.g. one or more CPUs, which govern the operation of the device 1, preferably in a programmable manner, through the execution of suitable instructions;
volatile memory means 12, e.g. a random access memory RAM, in signal communication with the control and processing means 11, wherein said volatile memory means 12 store at least instructions that can be read by the control and processing means 11 when the device 1 is in an operating condition;
non-volatile memory means 13, e.g. one or more magnetic disks (hard disks) or a Flash memory or another type of memory, in signal communication with the control and processing means 11 and with the volatile memory means 12, and wherein said memory means 13 preferably store a set of instructions implementing the method according to the invention;
input/output means (I/O) 14, which can be used, for example, for connecting to said device 1 a number of peripherals (e.g. one or more interfaces allowing access to other non-volatile memory means, such as Flash or magnetic memories, so as to permit, preferably, copying information from the latter to the non-volatile memory means 13) or a programming terminal configured for writing instructions (which the control and processing means 11 will have to execute) into the memory means 12,13; such input/output means 14 may comprise, for example, a USB™, IEEE 1394, RS232, IEEE 1284, etc. adapter;
a communication bus 17 allowing information to be exchanged among the control and processing means 11, the volatile memory means 12, the non-volatile memory means 13, and the input/output means 14.

As an alternative to the communication bus 17, the control and processing means 11, the volatile memory means 12, the non-volatile memory means 13, and the input/output means 14 may be connected by means of a star architecture.

It must be pointed out that the non-volatile memory means 13 may be replaced with remote non-volatile memory means (e.g. a Storage Area Network—SAN) not comprised in said device 1; to such end, the input/output (I/O) means 14 may comprise one or more mass storage access interfaces such as, for example, an FC (Fibre Channel) and/or an iSCSI (Internet SCSI) interface, so that the device 1 can be configured for accessing said remote non-volatile memory means.

Also with reference to FIGS. 2 and 3, the following will describe the operation of the device 1. When the device 1 is in an operating condition, the control and processing means 11 are configured to execute a method according to the invention for estimating at least one illumination value of an ambient where light sources (such as lamps or windows) are present; such method comprises the following phases:
an acquisition phase P1, wherein the following data are read from the memory means 12, 13 (which data may be either acquired from external input means 14 or generated by a simulation application running on the device 1):
   ambient data AD defining a plurality of points detected in said ambient, each one being defined by at least one set of coordinates that define its position in a three-dimensional space of said ambient;
   emission data ED defining a first set of said points, wherein each point of said first set represents a portion of one of said light sources L, and at least one emission value, representing a light intensity emitted by said portion of said light source L, is associated with said point;
   illuminance data ID defining a second set of said points, wherein each point of said second set represents a portion of said ambient illuminated by the light sources L, and at least one illumination value, representing an illumination intensity (e.g. expressed in the unit of measurement called lux) received by said portion of said ambient in an emission condition of said light sources L (which may vary depending on, for example, whether the lights are on or off, the duty cycle value at which the power supply unit of said light is operating, whether the curtains are open or closed, etc.) is associated with said point, wherein said emission condition is represented (or defined) by a set of emission values comprised in said emission data ED;
a training phase P2, wherein a neural network NN is trained, via processing means 11, by inputting (to said neural network NN) said ambient data AD and said emission data ED, and by forcing said neural network NN to output said illuminance data ID, wherein said processing means 11 are preferably configured to use a Stochastic Gradient Descent (SGD) algorithm with a mini-batch size of 10 and a learning rate of 0.01;
a determination phase P3, wherein second illuminance data ID are determined via said neural network NN (using the processing means 11 or dedicated execution means, such as, for example, FPGAs, GPUs, or the like) on the basis of said ambient data AD and second emission data ED that define, for each point of said first set, an emission value representing a light intensity emitted by a portion of one of said light sources L, and wherein said second illuminance data estimate, for each point of said second set, an illuminance value representing an illumination intensity that should be received by a portion of said ambient.

This permits estimating the illumination of three-dimensional ambients defined by means of a cloud of points (e.g. a sparse model). In this way, simulation times are reduced for both simple and complex environments, and these models can be used for controlling the ambient illumination in real time, without having to use a geometric/vectorial model to make the illumination estimates and/or without requiring the intervention of a CAD operator to convert a sparse model of an ambient (whether physical or virtual) into a geometric/vectorial model.

The neural network NN makes it possible to estimate the quantity of light illuminating a point that belongs to a surface in a three-dimensional space, i.e. the illuminance thereof. Such quantity depends on the properties of the material, the position of the light sources, and the orientation of the other points in the ambient, etc. In its simplified form, an illuminance value (E) of a specific point of the ambient can be calculated by using the following formula:

$$E = L \frac{π}{ρ} \qquad ( 1 )$$

where L is the reflected radiance of said point, π is Archimedes' constant, whereas ρ is the reflectivity factor of the surface to which said point belongs (also known as Bidirectional Scattering Distribution Function (BSDF)).

The training phase P2 of the method according to the invention allows generating the neural network NN capable of estimating the illuminance data by learning the relation between the input (the ambient data AD and the emission data ED) and the illuminance values, thus approximating the above-mentioned function.

More in detail, the neural network NN is preferably of the hierarchical convolutional (hierarchical-CNN) type; such network comprises the following blocks:
a convolutional block, preferably of the relation-shape type, RS-CNN, which receives as input at least the ambient data AD and the emission data ED and outputs intermediate data;
an output block OB that receives as input said intermediate data and outputs the illuminance data ID.

During the training phase P2, the output block OB is configured to regress the illuminance values at each point comprised in the ambient data AD inputted to the neural network NN.

This makes it possible to improve the illuminance prediction without having to resort to a geometric/vectorial model, because the relation-shape convolutional block can learn the local geometric properties of the ambient data (cloud of points). In fact, this property proves extremely advantageous in the field of application of this method, in that it can be assumed that the propagation of light in the internal space of an ambient will tend to show a similar distribution in adjacent areas, and hence at adjacent points.

This approach can be used for illumination prediction purposes, since simulation times are reduced, and these models can also be used for controlling ambient illumination in real time, without requiring the use of a geometric/vectorial model to make the illumination estimates and/or without requiring the intervention of a CAD operator to convert a sparse model of an ambient (whether physical or virtual) into a geometric/vectorial model.

More in detail, the relation-shape convolutional block RS-CNN preferably comprises the following elements:
a first multilayer perceptron MLP1 having three hidden layers, which receives as input at least the ambient data AD and the emission data ED;
an aggregation layer AGG which uses a maximum (max-pooling) function as aggregation function and receives as input the data outputted by the first perceptron MLP1, preferably transformed by a transform layer;
an activation layer ACT that uses a non-linear activation function of the ReLU (Rectified Linear Unit) type and receives as input the data outputted by the aggregation layer AGG;
a second multilayer perceptron MLP2 having a single hidden layer, which receives as input the data outputted by the activation layer and outputs data that are inputted to the output block OB.

Finally, the output block OB preferably comprises a plurality of feature propagation layers that produce, as output, the illuminance data ID.

As will be discussed below, this configuration advantageously ensures a substantial reduction in the time necessary for computing the illuminance data (for simulation or control purposes) without any significant degradation in terms of precision of the output illuminance data, thus making it possible to reduce the use of geometric/vectorial models in order to make the illumination estimates and/or to avoid having to resort to a CAD operator for converting a sparse model of an ambient (whether physical or virtual) into a geometric/vectorial model.

In order to further improve the precision of the illuminance data ID, the training phase P2 preferably comprises a normalization step, during which a batch normalization is applied to the first multilayer perceptron MLP1 and to the second multilayer perceptron MLP2, so as to increase the stability of the outputs of such elements and hence improve the precision of the results of the whole neural network NN.

In this manner, it becomes possible to use a neural network to reduce the simulation times necessary for estimating the illuminance data, and also to use such neural network for controlling the ambient illumination in real time, without having to use a geometric/vectorial model and/or without requiring the intervention of a CAD operator for converting a sparse model of an ambient (whether physical or virtual) into a geometric/vectorial model.

As aforesaid, the data inputted to the neural network NN comprise the ambient data AD and the emission data ED; such data are preferably organized into a matrix of N×C size, where N is the number of points contained in the ambient data and C is a dimension of a vector containing at least the coordinates (e.g. in Cartesian format) of one of the points defined by the ambient data AD and the emission value associated with such point, wherein said emission value is preferably 0 for those points which do not belong to light sources.

In addition to the above, the vector of dimension C may also contain a reflectance value representative of a reflectance property of a material of the surface represented by the point with which said reflectance value is associated. In other words, during the acquisition phase P1, reflectance data are preferably also acquired (via the input means 14) which associate a reflectance value with at least one point representing a portion of said ambient illuminated by said light sources L (second set), wherein said reflectance value represents a reflectivity property of a material of a surface represented by said point; furthermore, during the training phase P2 the neural network NN is trained by inputting also said reflectance data, and during the determination phase P3 the (second) illuminance data ID (i.e. the illuminance estimates) are determined also on the basis of said reflectance data.

This advantageously permits increasing the precision of the illuminance estimates and also training the neural network NN in a manner independent of the materials composing at least part of the surfaces of the ambient defined by the ambient data AD, so that the reflectivity of the surface whereon one or more points lie can be changed without having to train the neural network NN again. This reduces the need for using a geometric/vectorial model in order to make the illumination estimates and/or for resorting to a CAD operator for converting a sparse model of an ambient (whether physical or virtual) into a geometric/vectorial model.

In combination with or as an alternative to the above, the vector of dimension C may also contain an orientation datum that defines (e.g. by means of a triplet of values) a vector oriented orthogonally to the surface represented by the point with which said orientation datum is associated. In other words, during the acquisition phase P1 orientation data are preferably also acquired (via the input means 14) which associate with at least one point representing a portion of said ambient illuminated by said light sources L (second set) a vector oriented orthogonally to a surface represented by such point; furthermore, during the training phase P2 the neural network NN is trained by inputting also said orientation data, and during the determination phase P3 the (second) illuminance data ID (i.e. the illuminance estimates) are determined also on the basis of said orientation data.

This advantageously permits increasing the precision of the illuminance estimates and also training the neural network NN in a manner independent of the orientation of specific surfaces (e.g. windows, glass-panelled doors, or the like) that are present in the ambient defined by the ambient data AD, so that the orientation of at least one surface whereon one or more points lie can be changed without having to train the neural network NN again. This reduces the need for using a geometric/vectorial model in order to make the illumination estimates and/or for resorting to a CAD operator for converting a sparse model of an ambient (whether physical or virtual) into a geometric/vectorial model.

In combination with or as an alternative to the above, the vector of dimension C may also contain a size datum that defines (e.g. by means of an integer, fixed-point or floating-point value) a size (e.g. a diameter) of one of the light sources L. In other words, during the acquisition phase P1 size data are preferably also acquired (via the input means 14) which associate with at least one point representing a portion of one of said light sources L (first set) a size of such light source L (or part thereof); furthermore, during the training phase P2 the neural network NN is trained by inputting also said size data, and during the determination phase P3 the (second) illuminance data ID (i.e. the illuminance estimates) are determined also on the basis of said size data.

This advantageously permits increasing the precision of the illuminance estimates and also training the neural network NN in a manner independent of the size of at least one of the light sources L, so that the size of at least one light source L (whereon one or more points lie) can be changed without having to train the neural network NN again. This reduces the need for using a geometric/vectorial model 1 in order to make the illumination estimates and/or for resorting to a CAD operator for converting a sparse model of an ambient (whether physical or virtual) into a geometric/vectorial model.

As aforementioned, the neural network NN is able to estimate in real time the illuminance of a scene defined by a cloud of points (i.e. the ambient data AD), which can be generated starting from either a geometric/vectorial model produced by a CAD application (preferably by spatial sampling) or from a survey of a real ambient.

In order to experimentally prove the effectiveness of the solution according to the invention, the neural network NN was trained using a Stochastic Gradient Descent (SGD) algorithm with a mini-batch size of 10 and a learning rate of 0.01; the ambient data and the emission data were generated starting from geometric/vectorial models created by means of a CAD application, generating a cloud of 7,168 points per scene by spatial sampling of the corresponding geometric/vectorial model. During the training phase P2, illuminance data were generated by means of illuminance software libraries like Radiance™, which were inputted a geometric/vectorial model to output experimental illuminance data, which were then compared with the illuminance data produced by the neural network NN in order to assess the absolute distances between the luminance values of the two datasets, so as to minimize said distances by means of the learning process. This process was automated using the Pytorch™ and Torch-Point3D™ software libraries.

Using a personal computer comprising an Intel® Xeon® CPU E5-2620 v2 processor, 31.3 GB of RAM and a Geforce GTX 1080 GPU as a testing platform, the time necessary for computing the illuminance values of the entire cloud of points defined by the ambient data AD was approximately 0.03 sec. This makes the solution proposed herein suitable for use in environments where time constraints needs to be met, and hence for real-time control applications.

In order to test the invention as objectively as possible, a training dataset was created, and the test was carried out starting from geometric/vectorial models of 2,000 ambients characterized by different levels of complexity and occlusion, where occlusions were due, for example, to the presence of extrusions of walls and objects.

Using this dataset for the training and testing processes, we defined a metric for evaluating the precision of the illuminance estimates produced by the method according to the invention in comparison with the state of the art (which uses geometric/vectorial models). By grouping the different test scenes according to scene complexity and presence of occlusions, it was possible to observe a reduction in the execution time necessary for computing the illuminance data, which turned out to be 850 times shorter than in the prior art, with a mean error increase as low as 8%, even for very complex ambients.

Of course, the example described so far may be subject to many variations.

Also with reference to FIG. 4, the following will describe a first variant of the invention; such variant comprises an apparatus 2 (e.g. an embedded device, a development board, or the like), which comprises the following components:
execution means 21, e.g. one or more CPUs, GPUS, DSPs, FPGAS and/or the like, preferably implementing, through hardware and/or software means, the neural network NN configured and trained as described with reference to the main embodiment;
volatile memory means 22, e.g. a random access memory RAM, in signal communication with the control and processing means 21. When the device 2 is in an operating condition, said volatile memory means 12 store ambient data that define, as previously described, a plurality of points detected in said ambient, each of which is defined by at least one set of coordinates defining its position in a three-dimensional space of said ambient;
non-volatile memory means 23, preferably one or more magnetic disks (hard disks) or a Flash memory or another type of memory, in signal communication with the execution means 21 and with the volatile memory means 22, wherein said non-volatile memory means 23 contain information that makes it possible to configure and/or operate the neural network NN (e.g. a set of internal weights, numbers of levels in the various layers, or the like);
input/output (I/O) means 24, which can be connected to power supply means that supply power to one of said light sources L, e.g. one or more power supply units with a PWM output, adapted to adjust the luminous power of one or more of the light sources L. These input/output means 24 may comprise, for example, a USB™, IEEE 1394, RS232, RS485, IEEE 1284 adapter, or the like;
a communication bus 27 allowing information to be exchanged among the execution means 21, the volatile memory means 22, the non-volatile memory means 23, and the input/output means 24.

More in detail, the input means 24 are configured to acquire the emission data ED, which, as previously described, define a first set of said points, wherein each point of said first set represents a portion of one of said light sources L, and an emission value is associated with said point which represents a light intensity emitted by said portion of said light source L.

When the apparatus 2 is in an operating condition, the execution means 21 are configured to determine the illuminance data ID, via the neural network NN, on the basis of the ambient data AD and the emission data ED, wherein said illuminance data define, as previously described, a second set of said points, wherein each point of said second set represents a portion of said ambient illuminated by said light sources L, and an illuminance value is associated with said point and estimates an illumination intensity that should be received by said portion of said ambient.

This approach can be used for illumination prediction purposes, since simulation times are reduced, and these models can also be used for controlling ambient illumination in real time, without requiring the use of a geometric/vectorial model to make the illumination estimates and/or without requiring the intervention of a CAD operator to convert a sparse model of an ambient (whether physical or virtual) into a geometric/vectorial model.

In combination with the above, the execution means may also be configured for executing the following steps:
acquiring, via the input means 24, reference data defining at least one desired illuminance value for at least one point of the second set;
determining control data on the basis of said reference data and said illuminance data ID (e.g. on the basis of at least one arithmetic difference between a desired illuminance value and an estimated illuminance value for at least one point of said second set), wherein said control data define an emission condition of at least one of said light sources L (i.e. a controllable source), such as, for example, a duty cycle value at which a power supply unit of a lamp should operate, a position of a rolling shutter or a curtain, or the like;
transmitting, via the output means 24, control data.

This makes it possible to define target illuminance values for specific portions of an ambient (e.g. a desk, a work surface, or the like) and maintain such illuminance values independently of any other disturbing elements, such as increased or decreased natural lighting (e.g. due to the presence of clouds blocking the sun), activation or deactivation of other light sources, etc. In this respect, it must be pointed out that a first portion of the emission data ED can be detected by illumination sensors arranged in the ambient (e.g. near windows, video cameras, or the like), while a second portion of said emission data ED can be determined on the basis of the operating state of the lighting devices that are present in said ambient or in nearby ambients.

It is thus possible to control the ambient illumination in real time, without having to use a geometric/vectorial model to make the illumination estimates and/or without requiring the intervention of a CAD operator to convert a sparse model of an ambient (whether physical or virtual) into a geometric/vectorial model.

Some of the possible variants of the invention have been described above, but it will be clear to those skilled in the art that other embodiments may also be implemented in practice, wherein several elements may be replaced with other technically equivalent elements. The present invention is not, therefore, limited to the above-described illustrative examples, but may be subject to various modifications, improvements, replacements of equivalent parts and elements without however departing from the basic inventive idea, as specified in the following claims.

1-16. (canceled)

17. Method for estimating at least one illumination value of an ambient where light sources are present, comprising:
an acquisition phase, wherein the following data are read from a memory:
ambient data defining a plurality of points detected in said ambient, each one defined by at least one set of coordinates that define a position in a three-dimensional space of said ambient,
emission data defining a first set of said points, wherein each point of said first set represents a portion of one of said light sources, and at least one emission value, representing a light intensity emitted by said portion of said light source, is associated with said each point of said first set,
illuminance data defining a second set of said points, wherein each point of said second set represents a portion of said ambient illuminated by said light sources, and at least one illumination value, representing an illumination intensity received by said portion of said ambient in an emission condition of said light sources, is associated with said each point of said second set, wherein said emission condition is represented by a set of emission values comprised in said emission data,
a training phase, wherein a neural network is trained, via processing means, by inputting said ambient data and said emission data to said neural network and by forcing said neural network to output said illuminance data,
a determination phase, wherein second illuminance data are determined, via said neural network, on the basis of said ambient data and second emission data that define, for each point of said first set, an emission value representing a light intensity emitted by a portion of one of said light sources, and wherein said second illuminance data estimate, for each point of said second set, an illuminance value representing an illumination intensity that should be received by a portion of said ambient.

18. The method according to claim 17, wherein the neural network is of the hierarchical convolutional type and comprises:
a relation-shape convolutional block that receives as input at least said ambient data and said emission data and outputs intermediate data, and
an output block that receives as input said intermediate data and outputs said illuminance data.

19. The method according to claim 18, wherein the relation-shape convolutional block comprises:
a first multilayer perceptron, which is so configured as to have three hidden layers and receives as input at least the ambient data and the emission data,
an aggregation layer, which uses a maximum function as aggregation function and receives as input the data outputted by the first perceptron,
an activation layer, which uses a non-linear activation function of the ReLU type and receives as input the data outputted by the aggregation layer,
a second multilayer perceptron, which is so configured as to have a single hidden layer, receives as input the data outputted by the activation layer, and outputs data that are inputted to the output block,
wherein said output block comprises a plurality of feature propagation layers that produce, as output, the illuminance data.

20. The method according to claim 19, wherein the training phase comprises a normalization step, during which a batch normalization of the first multilayer perceptron and second multilayer perceptron is carried out.

21. The method according to claim 20, wherein, during the acquisition phase, reflectance data are also acquired which associate a reflectance value with at least one point of the second set, wherein said reflectance value represents a reflectivity property of a material of a surface represented by said point, wherein, during the training phase, the neural network is trained by inputting also said reflectance data to said neural network, and wherein, during the determination phase, the second illuminance data are determined also on the basis of said reflectance data.

22. The method according to claim 21, wherein, during the acquisition phase, orientation data are also acquired which associate with at least one point of the second set a vector oriented orthogonally to a surface represented by said point, wherein, during the training phase, the neural network is trained by inputting also said orientation data to said neural network, and wherein, during the determination phase, the second illuminance data are determined also on the basis of said orientation data.

23. The method according to claim 22, wherein, during the acquisition phase, size data are also acquired which associate a size of one of said light sources with at least one point of said first set, wherein, during the training phase, the neural network is trained by inputting also said size data to said neural network, and wherein, during the determination phase, the second illuminance data are determined also on the basis of said size data.

24. A computer program product loadable into a memory of an electronic computer and comprising a portion of software code for the execution of the phases of the method according to claim 1.

25. A processing device comprising a controller and a processor configured for executing a set of instructions implementing the method for estimating at least one illumination value of an ambient according to claim 1.

26. An apparatus for estimating at least one illumination value of an ambient where light sources are present, comprising:
a memory comprising, at least, ambient data defining a plurality of points detected in said ambient, each point defined by at least one set of coordinates that define a position in a three-dimensional space of said ambient,
an input means configured for acquiring emission data defining a first set of said points, wherein each point of said first set represents a portion of one of said light sources, and an emission value is associated with said each point of said first set which represents a light intensity emitted by said portion of said light source,
an execution means configured for determining illuminance data, by means of a neural network, on the basis of said ambient data and said emission data, wherein said illuminance data define a second set of said points, wherein each point of said second set represents a portion of said ambient illuminated by said light sources, and an illuminance value is associated with said each point of said second set and estimates an illumination intensity that should be received by said portion of said ambient,
wherein said neural network is trained by inputting said ambient data and second emission data to said neural network and by forcing said neural network to output second illuminance data,
wherein said second emission data define, for said each point of said first set, at least one emission value representing a light intensity emitted by a portion of one of said light sources, wherein said second illuminance data define, for said each point of said second set, at least one illuminance value representing an illumination intensity received by said portion of said ambient in an emission condition of said light sources, and wherein said emission condition is represented by a set of emission values comprised in said second emission data.

27. The apparatus according to claim 26, wherein the neural network is of the hierarchical convolutional type and comprises:
a relation-shape convolutional block that receives as input at least said ambient data and said emission data and outputs intermediate data, and
an output block that receives as input said intermediate data and outputs said illuminance data.

28. The apparatus according to claim 27, wherein the relation-shape convolutional block comprises:
a first multilayer perceptron, which is so configured as to have three hidden layers and receives as input at least the ambient data and the emission data,
an aggregation layer, which uses a maximum function as an aggregation function and receives as input the data outputted by the first perceptron,
an activation layer, which uses a non-linear activation function of the ReLU type and receives as input the data outputted by the aggregation layer,
a second multilayer perceptron, which is so configured as to have a single hidden layer, receives as input the data outputted by the activation layer, and outputs data that are inputted to the output block,
wherein said output block comprises a plurality of feature propagation layers that produce, as output, the illuminance data.

29. The apparatus according to claim 26, further comprising output means that can be connected to power supply means that supply power to one of said light sources, wherein the execution means are also configured for:
acquiring, via the input means, reference data defining at least one desired illuminance value for at least one point of said second set,
determining control data on the basis of said reference data and said illuminance data, wherein said control data define an emission condition of at least one of said light sources,
transmitting, via the output means, said control data.

30. The apparatus according to claim 26, wherein the input means are also configured for acquiring reflectance data which associate a reflectance value with at least one point of the second set, wherein said reflectance value represents a reflectivity property of a material of a surface represented by said point, wherein the neural network is trained by inputting also said reflectance data to said neural network, and wherein the execution means are configured for determining the illuminance data, via said neural network, also on the basis of said reflectance data.

31. The apparatus according to claim 26, wherein the input means are also configured for acquiring orientation data which associate with at least one point of the second set a vector oriented orthogonally to a surface represented by said point, wherein the neural network is trained by inputting also said orientation data to said neural network, and wherein the execution means are configured for determining the illuminance data, via said neural network, also on the basis of said orientation data.

32. The apparatus according to claim 26, wherein the input means are also configured for acquiring size data which associate a size of one of said light sources with at least one point of said first set, wherein the neural network is trained by inputting also said size data to said neural network, and wherein the execution means are configured for determining the illuminance data, via said neural network, also on the basis of said size data.
